(19) United States
(12) Patent Application Publication
(10) Pub. No.: US 2020/0180034 A1
(43) Pub. Date: Jun. 11, 2020

(54) METHOD FOR COST-EFFECTIVE PRODUCTION OF ULTRAFINE SPHERICAL POWDERS AT LARGE SCALE USING THRUSTER-ASSISTED PLASMA ATOMIZATION

(71) Applicant: PYROGENESIS CANADA INC., Montreal (CA)

(72) Inventors: Christopher Alex DORVAL DION, Montreal (CA); François PROULX, Montreal (CA)

(21) Appl. No.: 16/632,337

(22) PCT Filed: Jul. 23, 2018
(86) PCT No.: PCT/CA2018/050889

§ 371 Date: Jan. 17, 2020

Related U.S. Application Data
(60) Provisional application No. 62/535,730, filed on Jul. 21, 2017.

(51) Int. Cl. B22F 9/08; B33Y 40/10

(52) U.S. Cl. CPC B22F 9/082; B22F 2009/088; B22F 2009/0836; B33Y 40/10

(57) ABSTRACT

A metal powder plasma atomization process and apparatus comprises at least one plasma torch, a confinement chamber, a nozzle positioned downstream of the confinement chamber and a diffuser positioned downstream of the nozzle. The nozzle accelerates liquid metal particles produced by the at least one plasma torch and also plasma gas to supersonic velocity such that the liquid metal particles are sheared into finer powders. The diffuser provides a Shockwave to the plasma gas to increase temperature of the plasma in order to avoid stalactite formation at an exit of the nozzle. The process increases both production rate of the metal powder and the yield of −45 μm metal powder.

### CROSS REFERENCE TO RELATED APPLICATIONS

This Application claims priority on U.S. Provisional Application No. 62/535,730, now pending, filed on Jul. 21, 2017, which is herein incorporated by reference.

### FIELD

The present subject-matter relates to the production of fine metal powders and plasma processing of materials.

### BACKGROUND

Fine and ultrafine spherical metal powders of 45 μm and less are used as feedstock for different manufacturing processes, such as 3D printing (additive manufacturing), metal injection molding (MIM) and Cold Spray Deposition. Still today, plasma atomization seems to be the technology providing the best yield of quality powders within that range. Moreover, powders produced by plasma atomization are recognized as among the best powders on the market due to their very high sphericity, small particle size, high particle density, excellent purity and flowability. On the other hand, because of the reasons mentioned hereinbelow, it is generally accepted that plasma atomization is an expensive technology to operate.

Originally, the plasma atomization process had a very low production rate (between 0.6 and 1.2 kg/h for Ti-6Al-4V) and a particle size distribution rather coarse (D_50 between 80 and 120 μm). See U.S. Pat. No. 5,707,419 entitled “Method of production of metal and ceramic powders by plasma atomization” and issued to Pegasus Refractory Materials & Hydro-Quebec [Reference 1]. However, over the last 10 years, multiple efforts have been concentrated towards the optimization of the production rate, which has been successful to some extent (between 5 and 13 kg/h), as well as a focus towards shifting the particle size particle to the finer side (maximization of the −106 μm and −45 μm cuts) [References 1 to 4]. Those two parameters indeed affect directly the commercial profitability of such technology. These incremental improvements were mainly focused on 1) preheating to the wire feedstock prior to the atomization zone for increasing the production rate, and 2) increasing the gas flow and pressure, in order to shift the particle size distribution to the finer side. Inconveniently, it is generally observed that increasing the production rate of an atomization system will strongly correlate with a shift of the particle size distribution towards the coarser side. Since there is a demand on the market for finer particles, this can be undesirable.

Even after these improvements, the plasma atomization family of processes remains very inefficient energetically, considering that a mere fraction of the power that is introduced into the system is used. For example, a typical plasma atomizer could use 3 plasma torches set at a power of 45 kW each and a preheat source of 8 kW to atomize a Ti-6Al-4V wire at a rate of 5 kg/h. This represents 143 kW of raw power to treat 5 kg/h, which translates into a specific thermal power input of 28.6 kW·h/kg. This represents more than 82 times the theoretical specific thermal power input requirement (0.347 kW·h/kg).

In terms of mechanical energy transfer, considering 3 plasma jets at 400 m/s, delivering 0.0192 kg/s each, this represents a kinetic power of 1.5 kW. Assuming an angle of 30 degrees from the wire with respect to the torches, about half is used only to accelerate the droplet. Then, the kinetic power required to break up the initial particles from 400 μm, down to 25 μm for example should be negligible (approximately 0.1 W) in theory. However, in practice, it remains hard to shift the complete distribution below 45 μm.

Although such inefficiency in terms of mechanical power is not directly measured, it does have a direct impact on the profitability of the process via gas consumption and sellable product yield. Argon is an example of gas that is commonly used in atomization of metals because it is chemically inert and relatively inexpensive. Due to its low efficiency, a typical plasma atomization process therefore consumes large quantity of argon per unit of mass of powder produced. It is common to see gas/metal mass ratios between 20 and 30, while in theory these values could get much closer to 1.

Therefore, even after all these years and iterations in the design of plasma atomizers, plasma atomization remains a costly and inefficient process.

Therefore, it would be desirable to provide an apparatus and/or a process for producing ultrafine spherical powders with minimal satellite at high capacity with a high yield of fine powders in the −45 μm range.

### SUMMARY

It would thus be desirable to provide a novel apparatus and/or process for producing ultrafine spherical powders at large scale using plasma-thrust pulverization.

The embodiments described herein provide in one aspect an apparatus for producing powder from a feedstock by plasma atomization, comprising:
at least one plasma torch for atomizing the feedstock to liquid particles; and
a device for accelerating the liquid particles and a mixture of at least one of a hot gas and plasma, said device being adapted to shear the liquid particles into finer ones.

Also, the embodiments described herein provide in another aspect an apparatus for producing powder from a feedstock by plasma atomization, comprising:
at least one plasma torch for atomizing the feedstock to liquid particles; and
a confinement chamber provided upstream of a nozzle, the confinement chamber being hot and being adapted to melt the feedstock prior to being fed to the nozzle.

Furthermore, the embodiments described herein provide in another aspect an apparatus for producing powder from a feedstock by plasma atomization, comprising:
at least one plasma torch for atomizing the feedstock to liquid particles and/or droplets; and
a device for accelerating with a hot gas the liquid particles to supersonic speed, said device being adapted to shear the liquid particles and/or droplets into finer ones.

Moreover, the embodiments described herein provide in another aspect a process for producing powder from a feedstock by plasma atomization, comprising:
atomizing the feedstock into liquid particles; and
accelerating the liquid particles and a mixture of at least one of a hot gas and plasma, such as to cause the liquid particles to shear into finer ones.

Moreover, the embodiments described herein provide in another aspect a process for producing powder from a feedstock by plasma atomization, comprising:
atomizing the feedstock into liquid particles; and
providing a confinement chamber upstream of a nozzle, the confinement chamber being hot and being adapted to melt the feedstock prior to being fed to the nozzle.

Moreover, the embodiments described herein provide in another aspect a process for producing powder from a feedstock by plasma atomization, comprising:
atomizing the feedstock into liquid particles and/or droplets; and
accelerating with a hot gas the liquid particles to supersonic speed, such as to shear the liquid particles and/or droplets into finer ones.

Moreover, the embodiments described herein provide in another aspect a particle used for at least one of 3D printing, metal injection molding (MIM) and cold spray deposition applications.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment.

FIG. 1 is a cross-sectional view of a conventional torch angle adjustment mechanism with induction pre-heating and using swiveling ball flanges;

FIG. 2 is a cross-sectional view of a thruster-assisted plasma atomization apparatus in accordance with an exemplary embodiment;

FIG. 3 is an illustration of a thruster-assisted plasma atomization during normal operation in accordance with an exemplary embodiment.

FIG. 4 is an enlarged schematic cross-sectional view of a thruster and diffuser of the plasma atomization apparatus in accordance with an exemplary embodiment;

FIG. 5 is a graph of a velocity profile for the plasma and a particle inside a chamber and thruster in accordance with an exemplary embodiment;

FIG. 6 is a graph of the Weber number profile along the chamber and thruster in accordance with an exemplary embodiment;

FIG. 7 is a picture of an example of powder produced by the present thruster-assisted plasma atomization process and apparatus in accordance with an exemplary embodiment;

FIG. 8 is a picture of an example of powder produced by the present thruster-assisted plasma atomization process and apparatus in accordance with an exemplary embodiment; and

FIG. 9 is a graph of a particle size distribution of a powder produced by the present thruster-assisted plasma atomization process and apparatus in accordance with an exemplary embodiment.

### DESCRIPTION OF VARIOUS EMBODIMENTS

The current subject-matter represents a significant improvement over the existing plasma atomization processes disclosed in References 1 and 2, namely U.S. Pat. No. 5,707,419 and PCT Publication No. WO 2016/191854, which are both herein incorporated by reference. In the present subject-matter, a “thruster” has been added at the apex zone, which increases significantly both the production rate (from 4.5-5 to 9-10 kg/h) and the yield of −45 μm powder (from ˜45 to ˜90%). Doubling the production rate and the yield of valuable product roughly translate into quadrupling the profitability of the process.

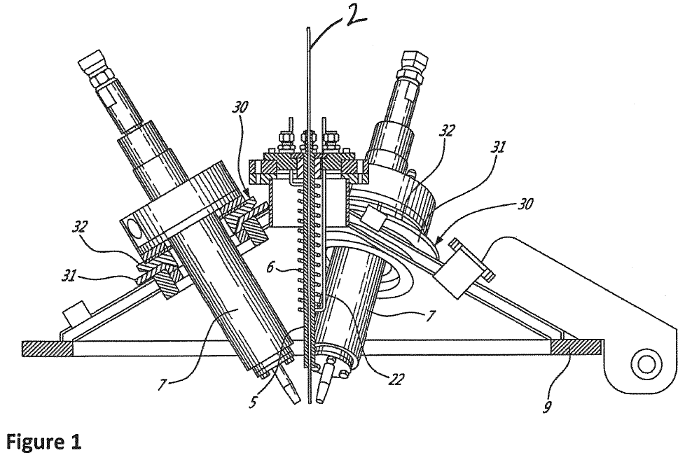

Before describing in details the present subject-matter, the plasma atomization apparatus for producing spherical powders from a wire of PCT Publication No. WO 2016/191854 will now be described. With reference to FIG. 1, the plasma apparatus of PCT Publication No. WO 2016/191854 basically uses three plasma torches which blast a supersonic plasma jet through De Laval nozzles. The wire is preheated by induction in a graphite sleeve, prior to being atomized at the apex.

More particularly, in the plasma apparatus of PCT Publication No. WO 2016/191854, a wire 2 provided on a metallic wire spool is uncoiled therefrom and is then fed through a wire feeder and straightener. The straight wire 2 is fed through a pass-through flange. Then, the wire 2 enters into a wire guide 5 that is surrounded by an induction coil 6, prior to being atomized by three plasma torches 7 at an apex thereof (the apex being the meeting point of the wire 2 and the three torches 7). The powder so produced passes through an aperture plate 9 and cools down as it falls down a reactor.

Once preheated, the wire 2 then reaches the apex, which is the zone where the wire 2 and the three plasma torches 7 meet for the atomization. The melting atomized particles freeze back to solid state as they fall down into a chamber of the reactor. The powder is then pneumatically conveyed to a cyclone. The cyclone separates the powder from its gas phase. The powder is collected at the bottom of a canister while clean gas is then sent, via outlet, to a finer filtering system. The canister can be isolated from the cyclone by a gas-tight isolation valve.

In the plasma apparatus of PCT Publication No. WO 2016/191854, the induction coil 6 is used to preheat the wire 2, which uses a single power supply and as the heat source does not encumber the apex zone. In this configuration, the wire preheating comes from a single uniform and compact source. Wire temperature can be controlled by adjusting induction power, which is a function of the current in the induction coil 6.

The pass-through flange is made of a non electrically conductive material to ensure that the whole reactor is insulated from the coil. The pass-through flange has two gas-tight holes equipped with compression fittings used for passing the leads 22 of the induction coil 6 into the reactor.

The wire guide 5 can be designed to either react with or to be transparent to induction. For example, the wire guide 5 could be made of alumina, or silicon nitride, which are transparent to induction. It could also be made of silicon carbide or graphite, which reacts with induction. In the latter case, the hot wire guide, heated by induction, will radiate heat back into the wire.

The adjustable torch angle mechanism of PCT Publication No. WO 2016/191854 is shown in FIG. 1, which mechanism includes swivelling ball flanges 30. The three plasma torches 7 are attached to the body of the reactor head using the swivelling ball flanges 30. The ball flanges 30 each include 2 flanges that fit into each other, namely a bottom flange 31 and an upper flange 32, which can swivel in accordance to each other. The bottom flange 31 that is connected to the reactor head is fixed, while the upper flange 32 can rotate up to an angle of 4° in every axis. Assuming the reactor head has been designed to have a nominal angle of 30°, this means that the plasma torches 7 can cover any angle between 26° and 34°.

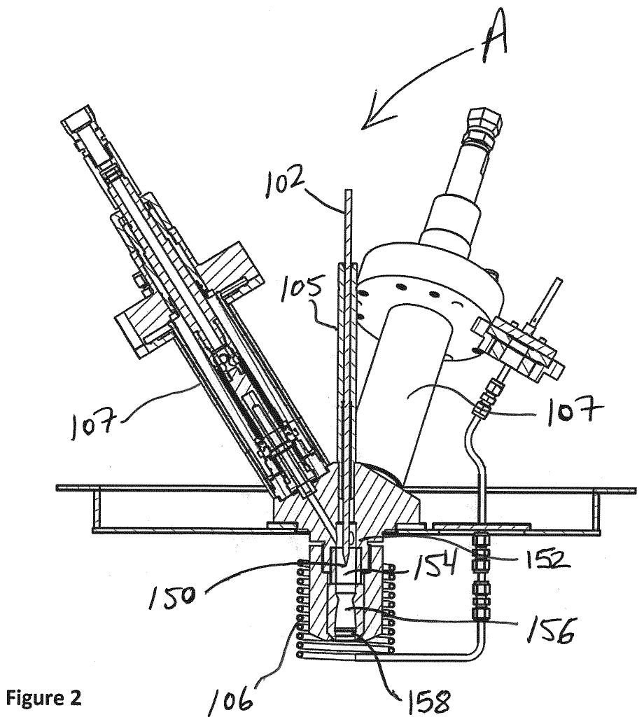

Now turning to the present subject-matter, a core piece has been added to the technology described hereinabove (i.e. PCT Publication No. WO 2016/191854), as depicted in FIG. 2. This core piece can be described as a “thruster”, in reference to rocket engines that use the De Laval nozzle concept.

In the present subject-matter, the De Laval nozzle is used to pulverize a high melting point solid material, e.g. a wire, into very fine droplets, using a high temperature thermal plasma accelerated to Mach velocities. In FIG. 2, the present thruster-assisted plasma atomization apparatus is identified by reference A. The wire is identified by reference 102, whereas the wire guide is denoted as reference 105, the induction coil by reference 106, and the three plasma torches by reference 107.

The core piece is substantially located at the apex 150, where the three plasma plumes meet with the wire 102 (the meeting point of the wire 102). The wire 102 is introduced at the top of a converging cap 152, which is used to join the plasma coming from the three plasma torches 107 with the wire 102 within a confinement chamber 154. It is in the confinement chamber 154 that the wire 102 melts and is primarily atomized into coarse droplets. The confinement chamber 154 allows confining the apex 150 into a very small space, where the wire 102 is to be melted and forcing the combined jets to exit through a supersonic nozzle and accelerate to several Mach speeds.

Indeed, downstream of the confinement chamber 154, there is provided a thruster 156, whereat the plasma is accelerated to supersonic speed and the liquid particles are sheared apart. At the exit of the thruster 156, a diffuser 158 is provided, which forces the jet to make shockwave to re-increase the plasma temperature at that point so as to avoid stalactite formations. The powder produced is ejected into a cooling chamber as it would in a conventional atomization process.

The induction coil 106 can be either placed at the bottom as shown in FIG. 2, at the top as shown in FIG. 1.

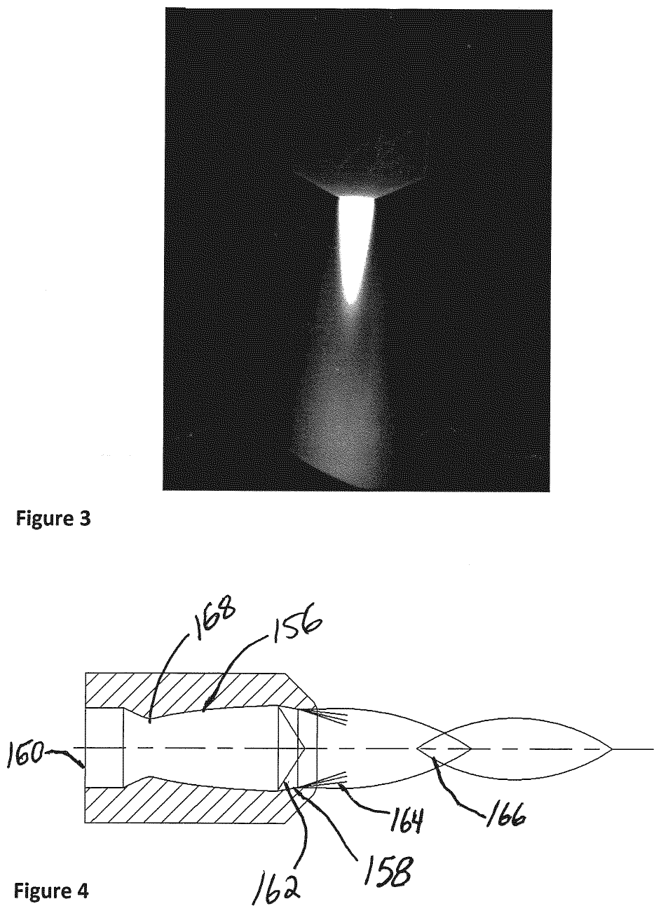

FIG. 3 shows the present subject-matter during normal operation, wherein the supersonic jet can be seen, with a stream of very fine powder coming out. This concept allows for significant improvements in terms of efficiency, both in terms of thermal and kinetic power.

The melted droplets and the plasma are accelerated in a converging diverging nozzle (thruster 156) where atomization occurs. During the acceleration, the temperature of the plasma plume drops significantly, which can cause the atomized material to freeze and accumulate at the exit of the plasma thruster 156, causing stalactite-like structures. To avoid this problem, the aforementioned diffuser 158 has been added at the end of the nozzle (thruster 156), as seen in FIG. 4. A channel for the entry of the atomizing gas and metal into the thruster 156 is denoted by reference 160.

The diffuser 158 creates a shockwave 162, which suddenly converts back the kinetic energy into thermal energy creating a high temperature zone. This creates a bright floating zone at the exit of the nozzle where the temperature is well above the melting point of the atomized metal, which allows keeping that zone sufficiently hot, so that stalactites cannot be formed. In other terms, the supersonic diffuser 158 at the outlet of the thruster 156 increases the gas temperature above the metal melting point, thereby preventing the accumulation of metal at the end of the nozzle. Prandtl-Meyer expansion waves 164, following this shockwave 162, further increase the gas velocity to reduce particle attachment. Reference 166 in FIG. 4 refers to shock diamonds.

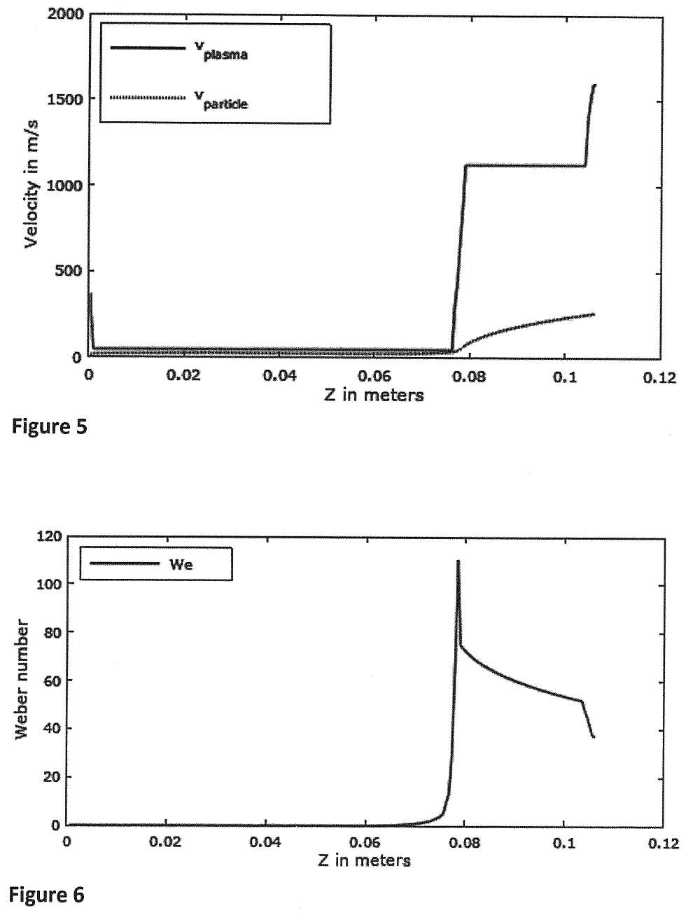

FIG. 5 shows the velocity profile of the plasma and the particle across the chamber 154 and the thruster 156, where ˜0.08 m corresponds to a throat 168 (FIG. 4) of the thruster 156. This figure was generated from numerical simulation of the process. It can be seen that the plasma accelerates drastically to Mach velocities and the particles are then accelerated by the plasma jet via drag forces; however the velocity difference remains significant between the two media. Velocity difference between the two fluids is what causes particle break-up.

FIG. 6 shows the Weber number profile within the chamber 154 and the thruster 156, where ˜0.08 m corresponds to the throat 168 of the thruster 156. The Weber number is used to predict whether there will be particle break-up. Weber numbers above 14 usually mean that break-up will occur. In FIG. 6, the Weber number reaches very high values (especially at the throat 168), which correspond to catastrophic break-up regime (when liquid particles explode into very fine articles all at once). This can explain the very fine powder obtained experimentally.

In terms of practical feasibility in the context of an industrial usage, the thruster and the confinement chamber need to be made from materials that can sustain the conditions. In the experiments, graphite was selected for the confinement chamber 154 and converging cap 152 as it will not melt, has a very high sublimation point at around 3900 K, and exhibits a strong resistance to thermal shocks. Graphite is also affordable, readily available and can be easily machined. Although graphite is sensitive to oxidation, it performs very well under inert or slightly reducing environment at very high temperature. For the thruster 156, a combination of high melting point and very high resistance to mechanical erosion is required. In the present case, Titanium Carbide was selected, although many other materials such as Tungsten, Hafnium Carbide and Tantalum Carbide to name just a few, could have been used as well.

The experiments conducted were all exclusively focused on the following feedstock: ¼″ Ti-6Al-4V wire in feedstock. Under these conditions, a very high-quality powder was produced at 9 to 10 kg/h using 230 to 250 slpm of Argon per torch, with the occasional addition of helium to the plasma gas.

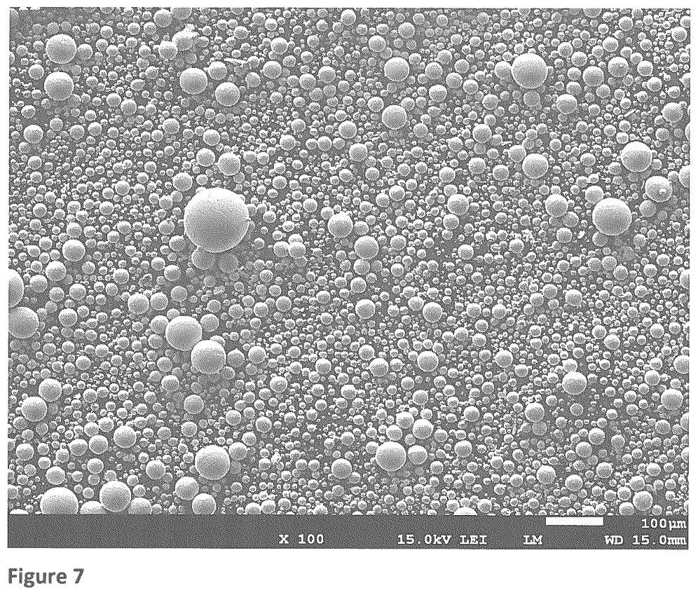

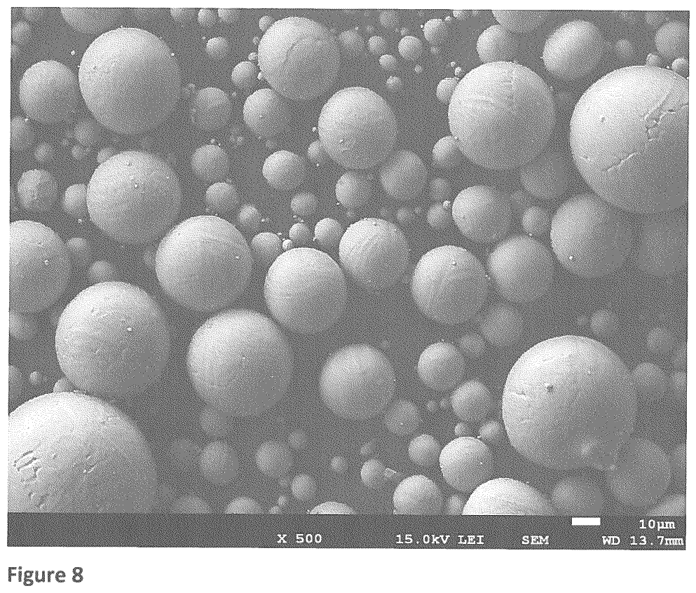

FIGS. 7 and 8 show examples of powder produced at 9 kg/h using the present subject-matter. It can be seen from these pictures that the satellite content of the powder produced with the new method/apparatus A is very low. It is believed that is due to the increased momentum of the particles which propels the particles further down the chamber, which reduces fine powder recirculation in the chamber which is known to be linked to satellite generation. Furthermore, the ˜200 nm boundary layer around the supersonic jet insulates the ambient gas from the new powder produced, which could also help in preventing the formation of satellites.

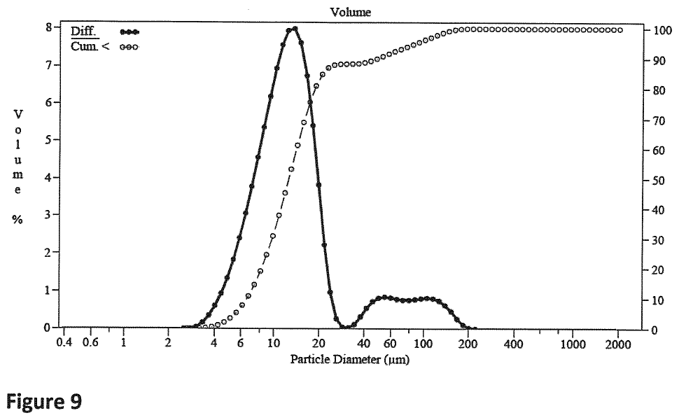

The particle size distribution of a powder produced by the present thruster-assisted plasma atomization process/apparatus A was also especially narrow with ˜90% of the distribution between 2 and 30 μm (see FIG. 9).

It is clear however that the integration of the thruster 156 in the plasma wire atomization process allows for other possibilities. For instance, a variant of the method lies in that the concept should not be limited only to wires. Since the thruster-assisted plasma atomization consists of a chamber that maximizes the contact between the material to be atomized and pulverized with the extreme temperature plasma, the effect of the size and shape of the material to be pulverized is much less critical. It seems that the method would work not simply with wires, but also with any type of material if it can be properly fed into the thruster inlet chamber. This includes powders, bars, ingots as well as a molten feed, etc.

While in most of the cases, argon plasma would be sufficient, it is indeed also possible to mix the plasma gas with some additives to adjust the plasma properties. For example, adding helium or hydrogen to an argon plasma improves the thermal conductivity of the plasma.

Adding an induction coil around the throat of the De Laval nozzle can be used to add energy to the system. Since the role of the thruster part is to convert thermal into kinetic energy, more heat can translate into a higher velocity. From experiments, it was shown that induction 106 could be placed either on the wire guide 2, as shown in FIG. 1 (i.e. Reference 2), or around the thruster 156, as shown in FIG. 2.

It is interesting to note that, in comparison with Reference 1 and 2 the plasma torch nozzles no longer need to be supersonic for the system to work. It is now beneficial to have a looser nozzle which does not choke the plasma to conserve the maximum energy within the plasma jet. This has the positive indirect impact of increasing the lifetime of the torches as well as their power efficiency.

It is noted that the present subject-matter is not limited to the use of a 3-torch configuration. Indeed, the apparatus A could be adapted to a 5-torch or even a single torch configuration, which would work just as well.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] Pegasus Refractory Materials & Hydro-Quebec, U.S. Pat. No. 5,707,419—“Method of production of metal and ceramic powders by plasma atomization”.
[2] PyroGenesis Canada Inc., PCT Publication No. WO 2016/191854—“Plasma apparatus for the production of high quality spherical powders at high capacity”.
[3] AP&C Advanced Powders & Coatings Inc., PCT Publication No. WO 2011/054113 A1—“Methods and apparatuses for preparing spheroidal powders”.
[4] AP&C Advanced Powders & Coatings Inc., PCT Publication No. WO 2017/011900 A1—“Plasma atomization metal powder manufacturing processes and systems therefore”.

1. An apparatus for producing powder from a feedstock by plasma atomization, comprising:
at least one plasma torch for atomizing the feedstock to liquid particles; and
a device for accelerating the liquid particles and a mixture of at least one of a hot gas and plasma, said device being adapted to shear the liquid particles into finer ones.

2. The apparatus of claim 1, wherein the acceleration device includes a nozzle.

3. The apparatus of any one of claims 1 and 2, wherein the apparatus includes a thruster adapted to accelerate the plasma to supersonic speed and to shear apart the liquid particles.

4. The apparatus of claim 3, wherein a diffuser is provided at a downstream end of the thruster, said diffuser being adapted to substantially prevent the formation of stalactites substantially at an exit of the nozzle, and/or to re-increase a plasma temperature at the exit.

5. The apparatus of claim 4, wherein the diffuser is adapted to force the jet to make a shockwave thereby re-increasing the plasma temperature thereat, for instance to avoid stalactite formation.

6. The apparatus of any one of claims 1 to 5, wherein the acceleration device is adapted to accelerate the liquid particles with a supersonic gas stream to such a degree that the particles leave an atomization zone and do not create a satellite-causing region.

7. The apparatus of any one of claims 1 to 6, wherein the acceleration device includes a de Laval nozzle.

8. The apparatus of claim 7, wherein a particle size distribution can be adjusted by varying the gas-metal ration and a shape of the de Laval nozzle.

9. The apparatus of any one of claims 1 to 8, wherein a confinement chamber is provided upstream of the acceleration device, the feedstock, such a wire, being adapted to melt and to be primarily atomized into coarse droplets in the confinement chamber.

10. The apparatus of claim 9, wherein a converging cap is provided upstream of the confinement chamber.

11. The apparatus of claim 9, wherein there are provided three plasma torches, and wherein a converging cap is provided upstream of the confinement chamber, the converging cap being adapted to bring the plasma of the three torches together into the confinement chamber.

12. The apparatus of any one of claims 1 to 11, wherein argon is used as a plasma gas.

13. The apparatus of claims 1 to 12, a plasma gas includes at least one additive to adjust the plasma properties, such as helium or hydrogen added to an argon plasma for improving a thermal conductivity of the plasma.

14. The apparatus of any one of claims 1 to 13, wherein the feedstock includes at least one of a wire, powders, bars, ingots and molten feed.

15. The apparatus of any one of claims 1 to 14, wherein there are provided three of five plasma torches.

16. An apparatus for producing powder from a feedstock by plasma atomization, comprising:
at least one plasma torch for atomizing the feedstock to liquid particles; and
a confinement chamber provided upstream of a nozzle, the confinement chamber being hot and being adapted to melt the feedstock prior to being fed to the nozzle.

17. The apparatus of claim 16, wherein the nozzle includes a supersonic nozzle.

18. The apparatus of any one of claims 16 and 17, wherein the apparatus includes a thruster located downstream of the confinement chamber and adapted to accelerate the plasma to supersonic speed and to shear apart the liquid particles.

19. The apparatus of claim 18, wherein a diffuser is provided at a downstream end of the thruster, said diffuser being adapted to substantially prevent the formation of stalactites substantially at an exit of the nozzle, and/or to re-increase a plasma temperature at the exit.

20. The apparatus of claim 19, wherein the diffuser is adapted to force the jet to make a shockwave thereby re-increasing the plasma temperature thereat, for instance to avoid stalactite formation.

21. The apparatus of any one of claims 18 to 20, wherein the thruster is adapted to accelerate the liquid particles with a supersonic gas stream to such a degree that the particles leave an atomization zone and do not create a satellite-causing region.

22. The apparatus of any one of claims 16 to 21, wherein the nozzle includes a de Laval nozzle.

23. An apparatus for producing powder from a feedstock by plasma atomization, comprising:
at least one plasma torch for atomizing the feedstock to liquid particles and/or droplets; and
a device for accelerating with a hot gas the liquid particles to supersonic speed, said device being adapted to shear the liquid particles and/or droplets into finer ones.

24. A particle as produced by the apparatus of any one of claims 1 to 23.

25. A process for producing powder from a feedstock by plasma atomization, comprising:
atomizing the feedstock into liquid particles; and
accelerating the liquid particles and a mixture of at least one of a hot gas and plasma, such as to cause the liquid particles to shear into finer ones.

26. The process of claim 25, wherein a nozzle is provided to accelerate the liquid particles.

27. The process of any one of claims 25 and 26, wherein the plasma is accelerated to supersonic speed so as to shear apart the liquid particles

28. The process of claim 27, wherein a thruster is provided for accelerating the plasma to supersonic speed.

29. The process of claim 28, wherein a diffuser is provided at a downstream end of the thruster, said diffuser being adapted to substantially prevent the formation of stalactites substantially at an exit of the nozzle, and/or to re-increase a plasma temperature at the exit.

30. The process of claim 29, wherein the diffuser is adapted to force the jet to make a shockwave thereby re-increasing the plasma temperature thereat, for instance to avoid stalactite formation.

31. The process of claims 25 to 30, wherein the liquid particles are adapted to be accelerates with a supersonic gas stream to such a degree that the particles leave an atomization zone and do not create a satellite-causing region.

32. The process of any one of claims 25 to 31, wherein a de Laval nozzle is provided for accelerating the liquid particles.

33. The process of claim 32, wherein a particle size distribution can be adjusted by varying the gas-metal ration and a shape of the de Laval nozzle.

34. The process of any one of claims 26 to 30, wherein a confinement chamber is provided upstream of the nozzle, the feedstock, such a wire, being adapted to melt and to be primarily atomized into coarse droplets in the confinement chamber.

35. The process of claim 34, wherein a converging cap is provided upstream of the confinement chamber.

36. The process of claim 34, wherein there are provided three plasma torches, and wherein a converging cap is provided upstream of the confinement chamber, the converging cap being adapted to bring the plasma of the three torches together into the confinement chamber.

37. The process of any one of claims 25 to 36, wherein argon is used as a plasma gas.

38. The process of claims 25 to 37, a plasma gas includes at least one additive to adjust the plasma properties, such as helium or hydrogen added to an argon plasma for improving a thermal conductivity of the plasma.

39. The process of any one of claims 25 to 38, wherein the feedstock includes at least one of a wire, powders, bars, ingots and molten feed.

40. The process of any one of claims 25 to 39, wherein there are provided three of five plasma torches.

41. A process for producing powder from a feedstock by plasma atomization, comprising:
atomizing the feedstock into liquid particles; and
providing a confinement chamber upstream of a nozzle, the confinement chamber being hot and being adapted to melt the feedstock prior to being fed to the nozzle.

42. The process of claim 41, wherein the nozzle includes a supersonic nozzle.

43. The process of any one of claims 41 and 42, wherein a thruster is provided, located downstream of the confinement chamber and adapted to accelerate the plasma to supersonic speed and to shear apart the liquid particles.

44. The process of claim 43, wherein a diffuser is provided at a downstream end of the thruster, said diffuser being adapted to substantially prevent the formation of stalactites substantially at an exit of the nozzle, and/or to re-increase a plasma temperature at the exit.

45. The process of claim 44, wherein the diffuser is adapted to force the jet to make a shockwave thereby re-increasing the plasma temperature thereat, for instance to avoid stalactite formation.

46. The process of any one of claims 43 to 45, wherein the thruster is adapted to accelerate the liquid particles with a supersonic gas stream to such a degree that the particles leave an atomization zone and do not create a satellite-causing region.

47. The process of any one of claims 41 to 46, wherein the nozzle includes a de Laval nozzle.

48. A process for producing powder from a feedstock by plasma atomization, comprising:
atomizing the feedstock into liquid particles and/or droplets; and
accelerating with a hot gas the liquid particles to supersonic speed, such as to shear the liquid particles and/or droplets into finer ones.

49. A particle as produced by the process of any one of claims 25 to 48.

50. A particle used for at least one of 3D printing, metal injection molding (MIM) and cold spray deposition applications.
